(19) United States
(12) Patent Application Publication
(10) Pub. No.: US 2014/0279637 A1
(43) Pub. Date: Sep. 18, 2014

(54) Web-based system, apparatus and method promoting hiring of persons with disabilities who self-identify

(71) Applicants: DYLAN MEHDI RAFATY, Dallas, TX (US); VESNA NOVAKOVIC RAFATY, DALLAS, TX (US)

(72) Inventors: DYLAN MEHDI RAFATY, Dallas, TX (US); VESNA NOVAKOVIC RAFATY, DALLAS, TX (US)

(21) Appl. No.: 14/214,866

(22) Filed: Mar. 15, 2014

Related U.S. Application Data
(60) Provisional application No. 61/802,447, filed on Mar. 16, 2013.

(51) Int. Cl. G06Q 10/10

(52) U.S. Cl. CPC G06Q 10/1053
USPC 705/321

(57) ABSTRACT

A computer-implemented system comprising an application accessible to job seeker users and employer users over a network via a browser on user computing devices, the application comprising a Job Seeker Database and a Posted Jobs Database, the Job Seeker Database comprising inputs by job seekers who self-identify as having a disability as required per a Terms of Use of the application, the job seeker Database comprising inputs by job seekers relating to job seeker functional skills and an indication whether the functional skill exists with or without an accommodation, the Posted Jobs Database comprising inputs by employers of essential functional skills for a job posted by the employer.

### CLAIM OF PRIORITY

This non-provisional patent application incorporates by reference in full and claims priority to Provisional Patent Application No. 61/802,447 by inventor Dylan M. Rafaty entitled “Web-based system, apparatus and method promoting hiring of persons with disabilities” and e-filed on Mar. 16, 2013.

### NOTICE REGARDING TRADEMARK

DylanListed is a trademark of DylanListed LLC.

### BACKGROUND OF THE INVENTION

The disclosed invention is generally directed to computer-implemented systems, especially web-based systems, that enable job seekers to apply for work and employers to post jobs and job skills and other types of training sponsored or provided by the employers and available to job seekers. More specifically the disclosed invention is directed to systems that serve a defined community that is a subset of the entire community of job seekers and is one comprising job seekers who self-identify as persons having a disability as required by the Terms Of Use of the system and its application. Thus the disclosed invention is directed to systems that enable all types of employers (public, private, large, small, federal contractors, not-for-profit organizations, others) to efficiently access a pool of job seekers with disabilities. The labor participation rate of job seekers with disabilities is significantly less than that for job seekers without disabilities. Recognizing this, for example, the US federal government has passed legislation aimed to encourage federal contractors to manage and continuously improve their hiring of persons with disabilities and has set a goal (not a quota) of 7% utilization per workgroup by select federal contractors and subcontractors. The disclosed system which brings in a one-stop national platform a community of job seekers who voluntarily self-identify will help federal contractors to show compliance with the new rules. The disclosed platform will also enable employers who are not federal contractors to access and recruit from a pool of qualified job seekers who self-identify. The disclosed invention is also directed to a system that brings in the one-stop platform service providers (‘herein called Advocates, for convenience only) such as but not limited to supported employment agents or other job seeker representatives who serve job seekers who have a disability as well as merchants who manufacture and market assistive technology products. Thus the disclosed one-stop platform also has a marketplace for the trying out of, purchasing and/or licensing of assistive technology products. The term ‘disability’ as used herein refers broadly to all types of disabilities including but not limited to physical, mobility-related, intellectual, cognitive, developmental and other types of disabilities and includes the federal government's definition of disability. The job seekers who access the disclosed platform are not required to, but may if they wish, disclose their particular type of disability in order to be considered for jobs posted on the platform, however, by an honor system and per the Terms of Use for the platform they affirm that they have a disability when they register to become a user of the platform. The focus of the platform is on the job seeker's current functional skills, with or without accommodation as noted by the job seeker. Sometimes persons with a disability are herein referred to as the ‘differently-abled.’

Known prior art systems for recruitment of persons with disabilities are typically offline, require job seekers to independently seek out advisors and/or advocates to help them to navigate the governmental programs and community employment options and employer requirements. This is inefficient for the job seeker. It is also inefficient for employers who would prefer to have better, more ready insight into the size of the talent pool of qualified persons with disabilities. Increasingly the disabled are being empowered thanks to the digital age, the Internet, social networks, and smartphones. Persons with disabilities successfully utilize technology today. Many job seekers with disabilities are also self-advocates and possess communication skills that are above average and that serve them well as they seek employment or becoming entrepreneurs. A subset of the population having a disability is able to take advantage of self-service systems such as the one herein described. Another subset of the disability population may still require assistance from an advisor and/or advocate and the disclosed system facilitates that situation as well.

U.S. Pat. No. 7,043,443 to is directed to a system for connecting client computer and employers over a network. It describes a client-directed, as opposed to job seeker-directed system, where client refers to welfare office, workforce development boards, schools-to-work programs, advocacy groups (see FIG. 3 of U.S. Pat. No. 7,043,443) and where job seekers information is input at a client computer. It is directed to client-driven, client-facilitated interview requests to employers. The Applicants posit herein a different perspective on the way the community of job seekers having a disability is managed through to employment. The disclosed invention is all about empowering the job seekers with technology (for promoting self-service) and incentivizing employers, as well as advocates and other service providers serving the disability community, to come together in one stop online portal for efficiencies and other value-added benefits as described herein. The Applicant is not aware of prior art web-based system that is a one-stop online portal and application directed to serving the community comprising jobs seekers who are persons having a disability who self-identify as individuals with disabilities (herein ‘JSWDs’) and adapted to promote self-service by such job seekers, promote efficiencies in employers' recruitment of selected jobs seekers with a disability, capturing of novel metrics relating to hiring of persons with a disability, building an online community and other features as disclosed herein. Thus the disclosed system is directed to features and functionalities for employment-enablement for persons with disabilities. It is estimated that currently 75% of persons with disabilities do not need any accommodations to perform essential job functions of a position in a workplace. Employers seeking disabled kind of diversity for their work sites will utilize the disclosed system because it is a one-stop shop.

It is further noted that the disclosed system, described in its preferred embodiment as one directed to job seekers who self-identify as having a disability, may be adapted for and utilized by another ‘at-employment-risk’ community of traditionally-underserved job seekers such as the poor, population comprising immigrants for whom English is a second language, unemployed caregivers of disabled veterans or other persons with disabilities or any other defined population that benefits from having a dedicated, one-stop online place for promoting employability, employment, community connectivity, training and career advancement for members of the community, where the community is a community that employers may want to efficiently reach or are incentivized to reach (perhaps by way of a government program linked to the community). The key is that such populations of job seekers self-identify as belonging to the named population and come to the described portal for services specially adapted for their needs.

### SUMMARY OF THE INVENTION

Disclosed herein is a web-based, computer-implemented platform or system that, per a preferred embodiment, facilitates the hiring of individuals who self-identify as having a disability. The terms ‘web portal’, ‘portal’ and ‘system’ are herein used interchangeably for convenience to refer to the disclosed computer-implemented system accessible to users over a network such as the Internet for enabling efficient access to and recruitment of JSWDs. Persons who self-identify as having a disability utilize the disclosed system to be automatically placed in a pool of job seekers upon creation of a Job Seeker Profile, to access in one place a universal Training Calendar, and importantly to connect with the community that serves persons with a disability via communication tools available directly from the platform. Because the named job seeker population is traditionally underserved, and even more so in times of high general unemployment, important features of the disclosed system are adapted to incentivize employers to utilize the system by providing value-adding benefits to employers while promoting efficiencies in recruitment, hiring of persons with a disability. The portal also facilitates communications (via channels of e-mail, SMS and optionally VoIP calls) to help promote efficiencies in the hiring process. Job seekers, Advocates and Employers opt in and select their preferred communication channel for communications via the platform. The disclosed system comprises automation features that save steps for Employers, Job Seekers and Advocates. The disclosed system's feature set is designed to promote Employer confidence in hiring persons with a disability. It is understood that postings on the Training Calendar by employers, schools, accessibility products merchants and others service providers include training that is soft skills training, accessibility products training, job skills training and other types of training and education.

Job Seeker (and sometimes also ‘job seeker”) as used herein refers to a person who self-identifies as having at least one disability and who subscribes to (becomes a registered user of) of the disclosed web portal (or sometimes referred to as ‘platform or ‘application’). A Job Seeker may optionally get the help of a third party in completing the Job Seeker's Profile. That third party is noted in the Job Seeker's Profile and may be a caregiver, a parent, a job coach or mentor, a teacher, principal or director of Special Education, a supported employment professional or other Job Seeker-authorized person. Employer as used herein refers to employer entities (federal agency, state agency, private employer, not-for-profit organization, federal contractor, other) and may also include person(s) who is(are) authorized representative(s) of such employer entity and who is a subscriber (registered user) of the disclosed web portal.

Job Seekers, who access and use the portal for free, create a Job Seeker Profile, with automated system-generated periodic e-mail communication prompting the Job Seeker to update his/her Job Seeker Profile at a system-pre-defined interval. Alternatively, the communication reminding the job seeker to update his/her Job Seeker Profile may be sent to the job seeker using the job seeker's specified preferred communication channel(s), namely e-mail, SMS text message to the job seeker's mobile phone and/or a voice call. The Job Seeker Profile preferably comprises Job Seeker-input content relating to the Job Seeker's functional abilities (e.g., optionally presented in a dropdown listing, with or without visual graphical icons for each functional skill, where the Job Seeker selects entries), geographical (e.g., city/state and/or zip code(s) preferences for employment, job-type preferences (e.g., volunteer, paid internship, unpaid internship, entry-level, part-time, full-time, temporary, contract), work hours (time of day) preferences or limitations (e.g., AM only, four hours per day maximum). The disclosed invention preferably comprises an automation feature called the Quick Match (for convenience only) pursuant to which the application compares selected information input by the Job Seeker against the requirements for a job per any specific job posting. The Quick Match feature may optionally be pre-defined by the application or an Employer may specify fields to be matched. Thus, per one embodiment of the Quick Match feature a job seeker's functional skills, workstyle preference, geographical availability area and education may be compared to and matched with the corresponding fields per a particular job posting. Additional types of automated matching functions may be defined that comprise a different mix of data elements for matching comparison between Job Seeker Profile data elements and the corresponding data elements per a Posted Jobs and they are within the scope of this invention. The Quick Match feature may serve to encourage Employers to focus on the true minimum requirements (sometimes referred to as ‘essential skills’ or ‘essential functional skills’) for effectiveness in the Posted Job in a way that may encourage hiring of persons with a disability for the Posted Job in ways not done in that past where there was not the distinct focus on ‘essential functional skills.’ It is expected that Employers and Advocates will develop very clear, possibly even standardized listing of essential functional skills for various jobs such that the Quick Match will be a useful and efficient way to quickly identify a pool of qualified job seekers who are candidates for posted jobs. It is noted too that in the Assistive Technology Products Marketplace of the disclosed platform, providers of assistive technologies will be able to associate or link their products to specific ‘functional skills’ such that an Advocate representing a job seeker or a job seeker will be able to more readily target an assistive technology product to meet the job seeker's needs for improvement in any given functional skill. In certain cases, vetting of the Job Seeker's Profile by an Advocate may be required by the Employer if an automatically matched Job Seeker indicates he/she possesses a given essential functional skill as required for the matched Posted Job. Per a feature of the preferred embodiment, the Employer is asked to specify whether the Employer requires that the Job Seeker's Profile be vetted by, for example, a supported employment agent with whom the Employer has a pre-existing contract or another third party that is a Job Seeker-authorized representative of the Job Seeker whom the Job Seeker authorized to vet his/her profile. For illustration, non-limiting examples of functional skills (preferably presented as a dropdown listing in the UI for the Job Seeker Profile building step, as well as the UI for the step where an Employer posts a job) are the following: telephone work (answering, making voice calls), customer service, call center skills, order fulfillment, working familiarity with Microsoft Office suite of software products, computer data entry, lifting of objects of a specified weight, use of social networks such as Twitter, Facebook, LinkedIn, building a Facebook Ad Campaign, building a website including creating a web design (visual aspects of the website), sales skills (products, services), marketing skills (building a marketing strategy and creating marketing collateral), taking inventory of goods at a warehouse, stocking of goods on shelves, bookkeeping, accounting, foreign language skills (oral, written), writing content for websites or blogs, project management (including working knowledge of select project management software systems), housekeeping, document processing (e.g., scanning, copying, collating, filing), mailroom services, graphic design, conducting research online (e.g. Google, other), familiarity with website analytics such as Google Analytics, driving a vehicle (possessing a valid driver's license), cooking a meal and following a recipe, organizing a work area, taking notes (such as in a class), conducting a survey (like at a mall), foodservice, serving as usher or host, graphic design, public speaking, making an inspection against a checklist or protocol, industrial design, engineering skills, creative skills (specify painting, photography, sculpting, other), working proficiency with assistive technology product(s) (specify), training or instructing others in a task, performing data analysis, organizing or running a campaign (such as campaign for an office), legal skills, contract negotiation skills, purchasing/ordering a product. It is anticipated that Employers will get creative and sophisticated in their identification of essential functional skills for a job. When an Employer inputs/creates a functional skill that is not currently in the dropdown listing of functional skills viewable by job seekers when they build their Job Seeker Profile, the newly added functional skill will automatically be visible in real time to Job Seekers during their profile building step.

In the Job Seeker Profile creation step the Job Seeker is preferably prompted to input the number of hours that the Job Seeker has spent to date in training (soft skills, job skills) and the type of training. Additionally, the Job Seeker is prompted to input information relating to the Job Seeker's employment history with an indication of the job-type held.

Upon building a Job Seeker Profile the Job Seeker is automatically, immediately and continuously and in real-time considered for all posted jobs on the platform without the need to search the Posted Jobs Database and/or take any additional express action to apply. This feature is herein called for convenience ‘Auto-apply’ and is considered to be an important feature of the disclosed system per its preferred embodiment. The community of job seekers who self-identify benefits from the convenience of this feature. Known job sites such as CareerBuilder.com for example always require a job seeker to take express action and apply for each job that is of interest to the job seeker or to apply for a job that the CareerBuilder application sees as a potential match or of interest to the job seeker. As previously noted, Job Seeker will receive periodic reminders from the application to be sure to keep their Job Seeker Profile and to be sure their account on the platform is active. This will help to ensure that data on the platform are accurate and of high quality as Employers will demand high quality job seeker data.

The Job Seeker may optionally take steps to contact (and/or hire) an Advocate from within the web portal by optionally creating and sending an e-mail to a selected Advocate based on the Job Seeker's selection criteria (e.g., geographical location) for the Advocate. For example, a Job Seeker may ‘hire’ an Advocate or supported employment representative to vet/review the Job Seeker's Profile. Some employers may require such vetting while other employers may not require such vetting. Per an optional feature of the disclosed invention, a Job Seeker may contact (hire, secure paid services) a representative of the platform's service provider and have that rep provide additional employment-related services to the Job Seeker. An example of this is when the Job Seeker wants assistance with the non-competitive employment seeking process offered by the federal government (and some state agencies, and possibly too private employers). The non-competitive employment seeking-process typically requires additional documentation from the Job Seeker (e.g., certification or proof of disability) and the platform rep can assist with the collection of the necessary information.

The disclosed system automatically notifies Job Seeker when his/her Job Seeker Profile has resulted in an automated match (per system-pre-defined automated match criteria) to (1) indicate that the Job Seeker may potentially be contacted by the Employer, (2) to prompt the Job Seeker to confirm he/she is presently available for employment, (3) to invite the Job Seeker to send an e-mail communication to the Employer expressing a present interest in the Posted Job, (4) to invite the Job Seeker to secure an optional vetting of his/her Job Profile by the Job Seeker's Advocate, and/or (5) to invite the Job Seeker to complete a screening questionnaire (if any) for the Posted Job that resulted in an automated match. If the Job Seeker modifies his/her employment availability status, an automatic e-mail communication is sent to Employers when the Job Seeker's Profile resulted in a matched in at least one Posted Job by said Employer. The Job Seeker Profile comprises optional information as provided by the Job Seeker, including but not limited to an Accommodation Request (per a system-supplied webform), information relating to the Job Seeker's Workstyle Preference (work alone, lead, manage or supervise others, work as a member of a team, highly interactive one-on-one), an indication of the Job Seeker's “Super Skill” defined herein as a skill for which the Job Seeker may have been recognized at school, in a prior job and/or a skill that the Job Seeker possesses with pride, an indication whether or not the Job Seeker has available access to transportation to the job site or instead needs to secure transportation to the job site, and an indication that the Job Seeker's profile has been vetted by a third party where the third party may be an authorized representative from a former employer or a current or former Job Seeker-authorized Advocate of the Job Seeker. The preferred embodiment of the Job Seeker Profile Vetting Feature is that the system automatically sends an e-mail communication to the Job Seeker's pre-authorized Advocate (i.e., the Advocate as per direct input by the Job Seeker who is invited to ‘link’ his/her Job Seeker Profile with an Advocate) by inviting the Advocate to vet (review, approve) the Job Seeker's Profile whenever the Job Seeker responds yes to a prompt in the Create Job Seeker Profile step asking whether the Job Seeker wants to secure vetting. Job Seekers may optionally search Posted Jobs and expressly apply to selected Jobs by sending an e-mail communication directly to the Employer who is the poster for the Job. Job Seekers may if they wish post their feedback on any posted accommodation in the Accommodation Wiki.

Employers, who are preferably paying subscribers to the portal, utilize the portal to create an Employer Profile, post jobs, optionally post screening questionnaires or other screening or test items for the posted jobs, publish and promote employer-delivered training courses serving the community of persons having disabilities (the training courses published in the universal Training Calendar), post actual accommodations the employer has made at a named specific employer site via a special purpose, keyword-searchable Wikipedia called an Accommodation Wiki, send interview requests (via a Job Seeker and/or Advocate-preferred communication channel) to Job Seekers and/or the Job Seeker-authorized agents or Advocates of the Job Seeker when a Job Seeker Profile is automatically matched with at least one Posted Job, and access some optional value-added features such as communication portals. The Posted Jobs profiles preferably comprise the elements of essential functional skills for the posted job, minimum education level, job type, geographic location for the job site, and job duration-related information. The Employer Profile preferably comprises employer-identifying information and prompts the Employer to input the Employer entity's past and current sponsorships of and/or participation in named community-related events and programs (which may optionally be presented in a listbox whereby the Employer selects entries from a listbox). Such information is visible to visitors and registered subscribers of the site who view Employer Profiles. The system sends automated periodic e-mails to Employers whose Job Posting(s) resulted in system pre-defined automated match (matches) prompting the Employer to indicate whether or not the Posted Job has been filled. When an Employer creates and/or modifies the Employer Profile, the Employer may be automatically prompted to make a donation to the service provider of the disclosed system. In the Employer Profile creation step the Employer is preferably prompted to indicate the Employer's willingness and readiness to participate in one or more system-identified Job Fairs where at least one Job Fair is a job fair produced by the service provider of the disclosed system. An Employer who is making a job posting may be asked whether the Employer has previously made an accommodation for the particular job and if yes, then the Employer is invited to provide information details for the accommodation actually made. So, for example the Employer may be asked to input the type of accommodation made (e.g., modification of a physical work area or workspace, modification of the scope of the job duties, making website, training or other items (documents) more accessible, or providing accessibility products. If the Employer inputs accommodation information during the job posting step, the Accommodation Wiki is automatically populated with that information (e.g., name of employer who made the accommodation, type of accommodation made, job title for the job for which an employee received accommodation, rough estimate of the cost of the accommodation (optional), and a measure or rating (if available) of the effectiveness of the accommodation made. A measure of effectiveness of an accommodation preferably includes an effectiveness rating by the employee receiving the accommodation and an effectiveness rating by the employer providing the accommodation. The employer's rating may optionally include a measure of the degree of employee's performance improvement on the job after the accommodation.

The disclosed system is adapted to promote greater awareness of disability-related diversity in the workplace and may even promote a spirit of competition among employers in achievement of goals in disability-related diversity. The system may also serve to incentivize and enable small and medium-sized businesses (SMBs or SMEs) to hire persons having a disability. Thus, per the preferred embodiment of the disclosed system, when an Employer creates an Employer Profile, a so-called DADA (Differently-Abled Diversity Achievement) Score Questionnaire prompts the Employer to answer pre-defined questions (see following questionnaire as non-limiting example of types of questions) and a DADA score is automatically calculated for that Employer and displayed on the Employer's profile:

What's your company's DADA score today?(A yes answer equals 10 points. A no answer equals zero points.)
1. My company has a written Diversity Policy that includes provisions relating to hiring of the disabled.
2. Within the last year my company has trained all employees in diversity.
3. My company is a user of the DylanListed™ platform.
4. My company has newly-hired at least one disabled worker in the past 12 months.
5. My company has retained at least one disabled worker for at least 12 months.
6. My company has provided accommodation for at least one disabled employee upon request from the employee.
7. At my company compensation for managers or executives is tied to achievement in diversity, including differently-abled diversity.
8. My company provides job skills and/or career advancement training for disabled workers independently or in partnership with a third party.
9. My company sponsors community events that foster awareness of the disabled in our community.
10. My company has a policy to preferentially select suppliers that implement a diversity policy that includes provisions relating to hiring of the disabled.

Advocates, who preferably are paying registered subscribers to the portal, are authorized representatives of entities that serve persons with disabilities by providing products (e.g., assistive devices, assistive technologies) and/or services such as but not limited to job skills training, soft skills training, services relating to supported employment for employed persons with disabilities. It is noted that departments of schools (such as for example Special Education Departments) may be Advocates who use the disclosed system. Advocates (and Employers) may post online training in the form of webinars for example, the training content readily accessible from the disclosed system by the community (Job Seekers, Employers, Advocates, site visitors) via an integrated Skype client (e.g., utilizing URIs for accessing select training-related content). Advocates optionally may send e-mails to Employers to make a referral on behalf of a Job Seeker or on behalf of a Job Seeker that has been automatically matched with a Posted Job.

Visitors to the portal who are not subscribers to the portal may view all pre-defined public content of the web portal including but not limited to public information per Employer Profiles, Advocate Profiles, DADA scores for Employers, and including published Reports that comprise metrics derived from data generated on the site and the universal Training Calendar. By way of illustration and not limitation, Reports may comprise metrics (real time and historical summaries per a period of time) such as the number of Employer subscribers, number of Job Seekers, number of Job Postings, number of Advocates, number of matches, number of Job Seekers hired and by job type, average time from system automated match to interview, average time from system automated match to hiring, a service ROI measure for Employers and Advocates, a retention metric (e.g., percentage of Job Seekers hired for full-time positions that remain in a position for more than a defined period of time such as for example one year), DADA score trends by Employer's industry sector, DADA score trends by geographical region, total number of training hours offered in a specified period of time by type of training (e.g., soft skills, skills for a specified trade, career advancement training), percentage of Job Seekers who post Accommodation Requests, percentage of Employers who make a posting on the Accommodation Wiki. The Reports preferably utilize visual, color graphics whenever practicable to communicate and display the metrics. Per an optional mobile phone application, accessible to users who download the mobile phone application to their mobile phones, registered users of the platform may receive push communications from the platform comprising updates on metrics such as number of job seekers on the platform, number of job postings, DADA scores by employer type (e.g. federal contractor) or industry sector of the employer, percentage of job seekers on the platform whose job seeker profile resulted in matches during a specified period of time and number of job seekers hired during a specified period of time.

Important features of the disclosed system are the Graphical User Interfaces which offer Job Seekers and other users of the system the option to select alternative UIs for accessibility (e.g. larger size of font for displayed content, turn on speech-to-text input, text-to-speech application, customize look and feel of a web page (e.g., present only one question or prompt input per page) depending upon his/her type of disability, whether visual impairment, hearing impairment or other. The alternative UIs are available on demand within the various functionalities of the disclosed system, including but not limited to creating/updating a Job Seeker Profile, viewing a Job Seeker Profile, creating and viewing a Job Posting, creating a Request for Accommodation, viewing the universal Training Calendar, viewing information in the Transportation Database, and streaming audiovisual content that is uploaded to the service by Advocates and other subscribers.

### BRIEF DESCRIPTION OF THE DRAWINGS

FIG. 1 shows a system topography per a preferred embodiment of the disclosed hosted system supporting hiring of persons with disabilities who self-identify.

FIGS. 2 and 2A show data elements or prompts for input by Job Seekers per a preferred embodiment for the UI for the step of creating a Job Seeker Profile

FIGS. 3 and 3A show data elements or prompts for input by Employers per a preferred embodiment for the UI for the Job Posting step by Employers

FIG. 4 shows data elements or prompts for input/action by Advocates per a preferred embodiment for the UI for use by Advocates

FIG. 5 shows data elements for input by Merchants of Assistive Technology Products per a preferred embodiment for the UI for the Assistive Technology Products Marketplace

### DETAILED DESCRIPTION OF THE DRAWINGS

FIG. 1 shows a system topography per a preferred embodiment of the disclosed system supporting hiring of persons with disabilities. The Applicant discloses a deployment on the public cloud of Microsoft Azure, however it will be obvious to one possessing ordinary skill in the relevant art that an alternative deployment on a private cloud or another public cloud such as Amazon Services is possible and within the scope of this disclosure. The architecture provides a secure and scalable solution. It is noted that the described system, described essentially as a SaaS (software-as-service), can also function as a PaaS (platform-as-service) when the system provider opens up its API and invites others to access and build upon the platform. Job seekers 1, employers 2 and advocates 3 may access the URL of the website portal 6 of the disclosed system hosted in a cloud (such as for example the public cloud of Microsoft Azure) via an Internet web browser 4 on their respective communication device (e.g., computer of the Job Seeker, Employer and Advocate, computers not shown). Authentication of registered subscribers (herein called Job Seekers, Employers and Advocates) to the system is preferably accomplished via WIF 7. The website services application 8 comprises all applications designed to deliver the functional features of the system. Thus, the website services application comprise an Active Directory for User/Group Management 9 for accomplishing granular security (i.e., defining what type of user (whether visitor, Employer, Job Seeker, or Advocate) can access each specified application and/or features), an optional Community Social Network 10, a Transaction Manager 11 for managing service subscription payments and optionally also donations and/or sponsorships, a Storage Asset Manager 12 providing a content management system for uploading, delivering, viewing, streaming of content (including audiovisual content), a Compute Asset Manager comprising an autoscaling functionality for optimizing performance of the disclosed system, and Third Party Speech Services 14 comprising Text-to-Speech application 15 and a Speech-to-Text application 16. The Website Services Application 8 is in communication with relational databases that comprise an Employer Database 18, a Job Seeker Database 22, an Advocate Database 19, a Training Database 20, a Requested Accommodations Database 21, A Posted Jobs Database 23, an optional Transportation Database 25 and an Accommodations Wiki 24. The Website Services Application further comprise Communication Services 26 that enable e-mail communications and the sending of text messages (SMS) to mobile devices of the registered subscribers who expressly opt into such communication channel when prompted during the step of creating a Job Seeker Profile, Advocate Profile and/or Employer Profile. Communication Services 26 also enable the automated e-mail communications and alerts that are sent by the system to Job Seekers, Employers and Advocates as appropriate and as described herein. Communication services 26 optionally comprises access to a contact center 29 that provides a DIY interface enabling Employers to launch automated outbound interactive VoIP call campaigns to Employer-specified contacts as well as access to a contact center 30 that comprises an Automated Attendant for Inbound Calls. The disclosed system optionally makes available the value-added communication capabilities (such as the DIY contact center) as a way to incentivize registered subscribers to consistently or frequently access and utilize the service. Employers and Advocates may initiate Skype video meetings directly from within the service via the Skype client. Where supported employment is utilized post-hiring, hired Job Seekers may be invited to participate in scheduled Skype video meetings with the Employer and the Job Seeker's Advocate present for the purpose of monitoring the Job Seeker's progress.

The Accommodations Wiki 24 feature allows Employers and Advocates to input information relating to actual (as opposed to hypothetical, recommended, or government-mandated) accommodations made in a workplace setting to accommodate persons having a disability. The Accommodations Wiki may comprise a webform (comprising a questionnaire) prompting the Employer and/or Advocate to input specific types of information in connection with posted accommodation information. The Accommodations Wiki is viewable by all visitors to the site and all registered users of the system. Per an optional feature, accommodation information posted by an employer at the job posting step automatically populates an accommodation entry into the Accommodation Wiki. Preferably, an accommodation posting comprises an indication of the type of accommodation made, an indication of the job title to which the accommodation is linked and an indication of the functional skill addressed by the accommodation. The accommodation entry may also identify a specific assistive technology product that was used in the accommodation. If such association with a specific assistive technology product is made, the Assistive Technology Marketplace will flag that particular assistive technology product offering as one that was used as an actual accommodation for a specified job title and/or specified functional skill. This information is useful to job seekers, employers and advocates in trying out or selecting assistive technology products for a particular need by a job seeker.

The optional Transportation Database comprises information relating to Transportation-Related Service Providers, including carpools created by the community on the site. Per a feature of the UI, during the step of creation of the Job Seeker Profile, the Job Seeker is automatically presented information relating to the availability of transportation services and Transportation Service Providers for the Job Seeker's indicated preferred geographical area. Advocates (such as, but not limited to Independent Living Centers) may be prompted to input information into the Transportation Services Database or alternatively the Transportation Database may automatically be populated with information downloaded from a third party source such as a governmental entity.

FIGS. 2 and 2A show data elements or prompts for input by Job Seekers per a preferred embodiment for the UI for the step of creating a Job Seeker Profile

FIGS. 3 and 3A show data elements or prompts for input by Employers per a preferred embodiment for the UI for the Job Posting step by Employers

FIG. 4 shows data elements or prompts for input/action by Advocates per a preferred embodiment for the UI for use by Advocates

FIG. 5 shows data elements for input by Merchants of Assistive Technology Products per a preferred embodiment for the UI for the Assistive Technology Products Marketplace (31) per FIG. 1.

Designing UIs that support all of the functionalities as described in this disclosure will be obvious to one of ordinary skill in the relevant art. Visual prompts (e.g., graphical (picture) icons) are preferably used whenever possible such as for example in the step of creation of the Job Seeker Profile where the job seeker is prompted to input his/her current functional skills with and without accommodation. Other known accessibility solutions for the UIs comprising the disclosed web-based application and mobile application shall be known to those of skills in the relevant art.

We claim:

1. A computer-implemented system comprising an application accessible to job seeker users and employer users over a network via a browser on user computing devices, the application comprising a Job Seeker Database and a Posted Jobs Database, the Job Seeker Database comprising inputs by job seekers who self-identify as having a disability as required per a Terms of Use of the application, the job seeker Database comprising inputs by job seekers relating to job seeker functional skills and an indication whether the functional skill exists with or without an accommodation, the Posted Jobs Database comprising inputs by employers of essential functional skills for a job posted by the employer.

2. The system per claim 1 wherein the Posted Jobs Database comprises an input by employers of a requirement that vetting of a job seeker profile is required for a job posted by the employer.

3. A computer-implemented method for receiving of applications from job seekers for an available job comprising the following steps:
Accessing over a network a web-based application comprising a Jobs Database and a Job Seeker Database, the Job Seeker Database comprising inputs by job seekers who are persons who self-identify as having a disability, the inputs comprising information relating to a job seeker's geographical availability for employment,
Posting to the Jobs Database information relating to an available job, including a geographical location of a work site of said job and the job's minimum essential functional skills,
Wherein all job seekers in the Job Seeker Database are automatically deemed to have applied for the available job without the need for the job seekers to expressly select and apply for the said job, providing that job seekers' inputs relating to the job seekers' geographical availability for employment matches geographical location of a work site of the said job as input in the Jobs Database.

4. The system per claim 1 wherein the application automatically generates a Quick Match communication to a job seeker, employer and, if applicable, the job seeker's supported employment representative, when the job seeker's inputs per the Job Seeker's Profile in the Job Seeker Database for geographical availability for employment, functional skills with or without accommodation, education and vetting of the Job Seeker's Profile match corresponding inputs of requirements for a job posting by the employer, the communication delivered in a preferred communication channel of the job seeker, employer and supported employment representative, as applicable.

5. The system per claim 1 wherein the automatic matching feature may be turned on or off by the employer for any given job posting when the employer posts a job to the Jobs Database.

6. The system per claim 1 wherein a job seeker inputting information to the Job Seeker Database may optionally designate an Advocate to vet the job seeker's information, and when the job seeker makes that designation, the application automatically sends an e-mail to the Advocate inviting the Advocate to communicate with the Job Seeker and vet the job seeker's information.

7. The system per claim 1 wherein employer user that is a federal contractor is prompted to designate a workgroup identifier for a given job posting, the workgroup identifier enabling the employer to calculate a utilization rate as required for reporting to the federal government office of federal contractor compliance.

8. The system per claim 1 further comprising a database that is an Assistive Technology Products Marketplace, the marketplace comprising reference information where references are users of specified assistive technology products listed on the marketplace, the information on references accessible to job seekers, employers and advocates who access the marketplace.

9. A mobile phone application comprising real-time feeds and display on mobile phones of users of information comprising metrics about number of job seekers who self-identify on a website application linked to the mobile phone application, number of jobs posted by geographical area, disability diversity metrics of employers by geographical area.

10. The system per claim 1 wherein upon the completion of inputs for a Job Seeker profile, the application automatically builds an exportable resume based on the Job Seeker Profile.

11. The system per claim wherein a Job Seeker's Profile comprises information that a caregiver or spouse of the job seeker is unemployed.
